(19) United States
(12) Patent Application Publication
(10) Pub. No.: US 2021/0264343 A1
(43) Pub. Date: Aug. 26, 2021

(54) INFORMATION PROCESSING SYSTEM AND INFORMATION PROCESSING METHOD

(71) Applicant: HONDA MOTOR CO., LTD., Tokyo (JP)

(72) Inventor: Kazuya Watanabe, Wako-shi (JP)

(21) Appl. No.: 17/153,306

(22) Filed: Jan. 20, 2021

(30) Foreign Application Priority Data
Feb. 21, 2020 (JP) 2020-028703

(51) Int. Cl. G06Q 10/06

(52) U.S. Cl. CPC G06Q 10/063112; G06Q 10/0633

(57) ABSTRACT

An information processing system includes a task acquisition unit configured to acquire a task to be presented to a driver, a load identification unit configured to identify a driving load, an output determination unit configured to determine whether the task is to be output to the driver or not, and a storage unit configured to store taste information on the driver. The output determination unit determines to output the task if a degree of divergence of the task from a taste of the driver is smaller than a threshold value based on the driving load.

### INCORPORATION BY REFERENCE

The present application claims priority under 35 U.S.C. § 119 to Japanese Patent Application No. 2020-028703 filed on Feb. 21, 2020. The content of the application is incorporated herein by reference in its entirety.

### BACKGROUND OF THE INVENTION

### Field of the Invention

The present invention relates to an information processing system and an information processing method that present a task involving a response action to a driver of a mobile unit such as an automobile.

### Description of the Related Art

In a mobile unit such as an automobile, it may be considered that a vehicle control device, a navigation (NAVI) device and/or an audio-visual (AV) device, for example, make a proposal of a driver assisting function, a proposal of a destination or a stop-off point or a proposal to play back music to a driver of the mobile unit in response to a request from, for example, the driver or in accordance with a state of the driving operation by the driver which can be determined from, for example, facial expressions of the driver and/or based on a physiological state of the driver or the atmosphere of the inside of the mobile unit, (see Japanese Patent Laid-Open No. 2019-178926, for example).

However, when a proposal is presented to a driver, the determination on whether the proposal is to be accepted or not may require varying degrees of the thinking ability of the driver. As a result, the driver may think that performing the determination is burdensome depending on some details of the proposal or the complexity of the traffic scene encountered by the driver at that time or may suffer an unexpected adverse effect such as being distracted by the determination while performing driving operations.

Particularly, the load (driving load) relating to driving operations on the driver varies momentarily in accordance with traffic conditions, and the degree of attention of the driver required for driving operations also varies. For that, according to some details of the proposal, it may be improper to present the proposal at that time depending on the current degree of driving load.

Because of the background above, it has been demanded to, in an information processing apparatus that presents a task involving a response action to a driver of a mobile unit such as a proposal to the driver, safely present various proposals without excessively dissipating the attention to driving operations of the driver.

### SUMMARY OF THE INVENTION

One aspect of the present invention is an information processing system including a task acquisition unit configured to acquire a task to be presented to a driver of a mobile unit, a load identification unit configured to identify a current driving load on the driver, an output determination unit configured to determine whether the acquired task is to be output to the driver or not in accordance with the driving load, and a storage unit, wherein the storage unit stores taste information regarding a taste of the driver, and the output determination unit calculates a degree of divergence of the acquired task from the taste of the driver based on the taste information on the driver and determines to output a request of the acquired task to the driver if the calculated degree of divergence is smaller than a threshold value calculated based on the identified driving load.

According to another aspect of the present invention, the task includes a proposal to the driver, and the output determination unit calculates the degree of divergence of the proposal included in the acquired task from the taste of the driver based on the taste information on the driver.

According to another aspect of the present invention, the storage unit stores taste divergence information on a mutual degree of divergence between a plurality of predetermined taste categories, and the output determination unit calculates a degree of divergence of the proposal included in the acquired task from the taste of the driver based on the taste divergence information.

According to another aspect of the present invention, the threshold value is set to be smaller as the driving load is larger.

According to another aspect of the present invention, the taste information is determined for the driver.

According to another aspect of the present invention, the threshold value includes a default threshold value not dependent on an individual driver and an inherent threshold value determined for each driver, and the output determination unit determines whether the acquired task is to be output to the driver or not by using the inherent threshold value if the driver satisfies a predetermined condition relating to a learning level of response with respect to the task.

Another aspect of the present invention is an information processing method including the steps of acquiring a task to be presented to a driver of a mobile unit by a task acquisition unit, identifying a current driving load on the driver by a load identification unit, and determining whether a request of the acquired task is to be output to the driver or not by an output determination unit, wherein in the determining, a degree of divergence of the acquired task from the taste of the driver is calculated based on taste information regarding a taste of the driver stored in a storage unit, and a request of the acquired task is determined to be output to the driver if the calculated degree of divergence is smaller than a threshold value calculated based on the identified driving load.

According to the aspects of the present invention, in an information processing apparatus that presents a task involving a response action to a driver of a mobile unit such as a proposal to the driver, various tasks can be safely presented without excessively dissipating the attention to driving operations of the driver.

### BRIEF DESCRIPTION OF THE DRAWINGS

FIG. 1 is a diagram showing a configuration of an information processing system according to the present invention;

FIG. 2 is a diagram showing a configuration of a use management server included in the information processing system shown in FIG. 1;

FIG. 3 is a diagram showing a configuration of an information processing apparatus included in the information processing system shown in FIG. 1;

FIG. 4 is a diagram showing an example of taste information stored in the use management server shown in FIG. 2;

FIG. 5 is a diagram showing an example of taste divergence information stored in the use management server shown in FIG. 2;

FIG. 6 is a diagram showing another example of the taste divergence information stored in the use management server shown in FIG. 2;

FIG. 7 is a diagram showing an example of a driving load table stored in the information processing apparatus shown in FIG. 3; and

FIG. 8 is a flowchart showing a procedure of operations by the information processing apparatus shown in FIG. 3.

### DETAILED DESCRIPTION OF THE PREFERRED EMBODIMENTS

Embodiments of the present invention are described below with reference to drawings.

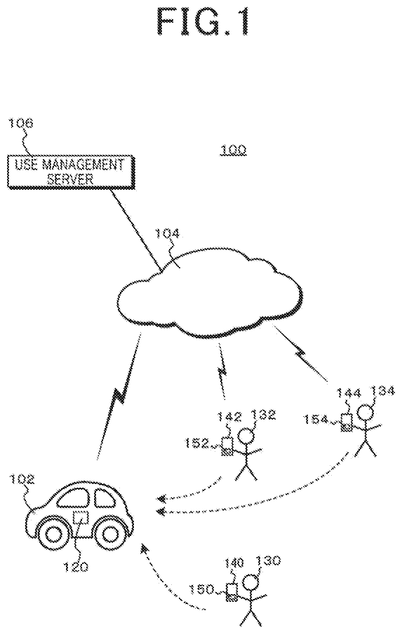

FIG. 1 is a diagram showing a configuration of an information processing system according to one embodiment of the present invention. An information processing system 100 includes, for example, an information processing apparatus 120 mounted on a vehicle 102 being a mobile unit and a use management server 106 provided externally to the vehicle 102. The information processing apparatus 120 and the use management server 106 are communicably connected over, for example, a communication network 104. The communication network 104 may be an open network such as the Internet or a private network.

The vehicle 102 is, for example, a shared car that can be used by a plurality of users, and each of a plurality of users 130, 132 and 134 can use the vehicle 102 as a driver of the vehicle 102. The users 130, 132 and 134 (hereinafter, also collectively called “users 130, etc.”) are people permitted to use the vehicle 102 by an owner of the vehicle 102 and use the vehicle 102 by using key information pieces 150, 152 and 154 (hereinafter, also collectively called “key information 150, etc.”) of an electronic key downloaded to mobile terminals 140, 142 and 144 (hereinafter, also collectively called “mobile terminals 140, etc.”) being, for example, mobile phones, respectively, in accordance with a conventional technology.

The vehicle 102 can acquire the key information 150, etc. from the mobile terminals 140, etc. used for use of the vehicle 102 and, based on the acquired key information, determine whether one user of the users 130, etc. has started the use of the vehicle 102 as a driver.

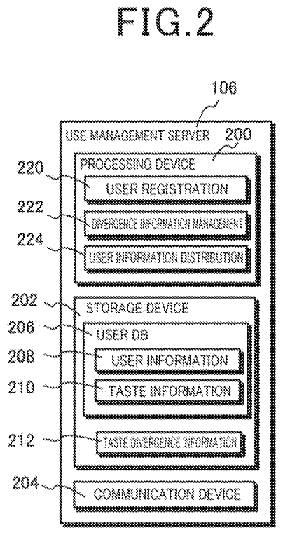

FIG. 2 is a diagram showing a configuration of the use management server 106. The use management server 106 includes a processing device 200, a storage device 202, and a communication device 204. The communication device 204 is a wired communication device and/or a wireless communication device for communicating with the information processing apparatus 120 over the communication network 104. The storage device 202 is configured by, for example, a volatile and/or nonvolatile semiconductor memory and/or a hard disk drive. The storage device 202 stores a user database (DB) 206. In the user DB 206, user information 208 and taste information 210 on each of the users 130, 132 and 134 are stored. Although FIG. 2 shows only one user information piece 208 and one taste information piece 210, it is understood that the equal numbers of the information pieces to the number of users exist because these information pieces are generated and stored within the user DB 206 for each user, as is described below.

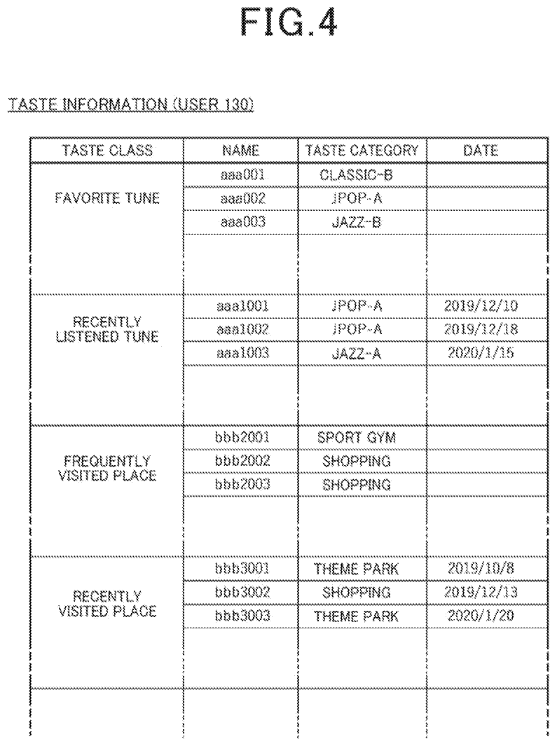

FIG. 4 is a diagram showing an example of the taste information 210. FIG. 4 shows the taste information 210 on the user 130 as an example. “TASTE CLASS”, “NAME”, and “TASTE CATEGORY” columns show a kind of taste that the user 130 has (hereinafter, “taste class”), the name of a specific taste target in the taste class, and the name of category to which the taste target belongs (hereinafter, also called “taste category”), respectively.

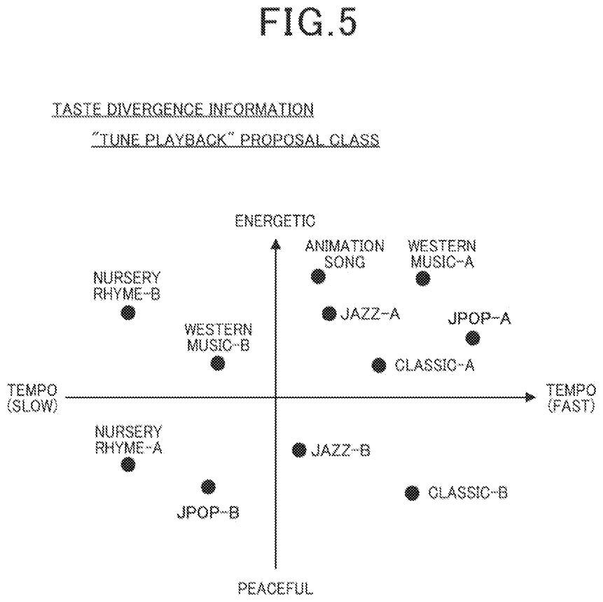

FIG. 4 shows, as taste classes, “FAVORITE TUNE”, “RECENTLY LISTENED TUNE”, “FREQUENTLY VISITED PLACE”, and “RECENTLY VISITED PLACE”. For example, specific tune names are shown in the “NAME” column corresponding to the “FAVORITE TUNE” class and the “RECENTLY LISTENED TUNE” class. Here, it is understood that “aaa001”, for example, shown in FIG. 4 represents a specific tune name (such as “Mozart, Turkish March”). The category of the specific tune shown in a “NAME” column is shown in the “TASTE CATEGORY” column corresponding to the “FAVORITE TUNE” class and the “RECENTLY LISTENED TUNE” class. Here, the category shown in the “TASTE CATEGORY” column is one of proposal categories represented by black circles on the two-dimensional plane shown in FIG. 5, which is described below, for example. A row corresponding to the “RECENTLY LISTENED TUNE” class has, in a “DATE” column, a date when the tune shown in the “NAME” column of the row has been listened.

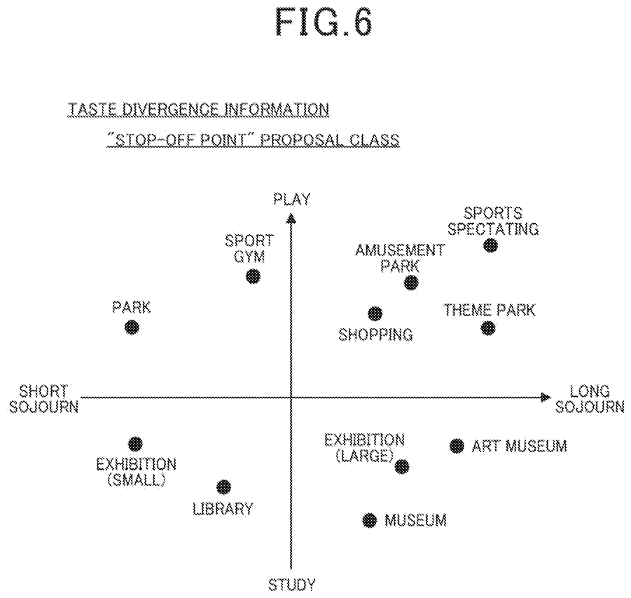

Referring to FIG. 4, for example, names of specific places are shown in the “NAME” column corresponding to the “FREQUENTLY VISITED PLACE” class and the “RECENTLY VISITED PLACE” class. Here, it is understood that “bbb2001”, for example, shown in FIG. 4 indicates a name of a specific place (such as “HACHIMANYAMA PARK” that is a name of a place or “FUJI SPORT GYM” or “AKAIWA SHOPPING CENTER” that is a name of a facility). A category of a specific place shown in the “NAME” column is shown in the “TASTE CATEGORY” column corresponding to the “FREQUENTLY VISITED PLACE” class and the “RECENTLY VISITED PLACE” class. Here, a category shown in the “TASTE CATEGORY” column is one of proposal categories represented by black circles on the two-dimensional plane shown in FIG. 6, which is described below, for example. A row corresponding to the “RECENTLY VISITED PLACE” class further has, in the “DATE” column, a date when the place shown in the “NAME” column of the row has been visited.

Referring to FIG. 2, the storage device 202 further stores taste divergence information 212 indicating, from the viewpoint of human sensibilities, a mutual degree of divergence (or degree of similarity) between a plurality of taste categories that can be used as taste representations of a driver. Here, the taste divergence information 212 is predetermined and is stored in the storage device 202, for example. The taste divergence information 212 is, specifically, information indicating, for each kind of proposal (hereinafter, “proposal class”) such as “tune playback proposal” and “stop-off-point proposal” that can be made by, for example, an AV output device 306, a navigation device 302 or the like, which is described below, the degree of divergence (or the degree of similarity) between types of proposal details (proposal categories) in the proposal class.

FIG. 5 is an example of the taste divergence information 212 and an example of information indicating the degree of divergence between proposal categories with respect to the “tune playback” proposal class. In FIG. 5, as the proposal category (type of proposal details in the “tune playback” proposal class), a total of 11 predetermined tune categories such as “WESTERN MUSIC—A” and “WESTERN MUSIC—B” indicating western music (rock) and western music (ballade), respectively, are used. In FIG. 5, tempo (the shown horizontal axis) and air (the shown vertical value) that tunes have are used as characteristics that have influences on human sensibilities, and, on a two-dimensional plane having them as axes, tune categories are positioned. Thus, in FIG. 5, the mutual distance between, for example, two arbitrary tune categories indicates a degree of divergence between the two tune categories. In other words, as the distance increases, it can be determined that the degree of divergence of the two tune categories increases. Here, each of the tune categories corresponds to a category of a plurality of tastes that can be used for taste representation of a driver.

The tempo is, for example, a speed of rhythm that a tune has, and the air is an impression that a human has on a tune (in the shown example, “PEACEFUL” and “ENERGETIC” are poles apart from each other). The position of each of black circles in FIG. 5 indicates, for example, an average or representative position of a tune in the corresponding tune category. In FIG. 5, each of the scales on the vertical axis and horizontal axis can be arbitrarily defined and set such that the tune categories are distinctively separated from each other.

The positions can be predetermined by a human or can be determined by an artificial intelligence (AI) that has learned a relationship between fluctuations of the number of acoustic vibrations that configure the tone quality, scale (such as C major or G minor) and/or melody of a tune and impression that a human has.

FIG. 6 is another example of the taste divergence information 212 and is an example of information indicating the degree of divergence between proposal categories with respect to the “STOP-OFF POINT” proposal class. In FIG. 6, as proposal categories (types of proposal details in the “STOP-OFF POINT” proposal class), a total of 11 predetermined stop-off point categories are used such as “SPORTS SPECTATING”, “AMUSEMENT PARK” and “THEME PARK”. In FIG. 6, a sojourn time (the shown horizontal axis) at a stop-off point and cognition of brain activities (where “PLAY” and “STUDY” are poles apart from each other, for example) are used as indices that have influences on human sensibilities, and, on a two-dimensional plane having them as axes, stop-off point categories are positioned.

Thus, in FIG. 6, like FIG. 5, the mutual distance between two arbitrary stop-off point categories, for example, indicates the degree of divergence between the two stop-off point categories. In other words, as the distance increases, it can be determined that the degree of divergence of the two stop-off point categories increases. Here, each of the stop-off point categories corresponds to a category of a plurality of tastes that can be used for taste representation of a driver. In FIG. 6, each of the scales on the vertical axis and horizontal axis can be arbitrarily defined and set such that the stop-off point categories are distinctively separated from each other.

The positions can be predetermined by a human or may be determined by an AI that has learned a relationship between, for example, names of places and the positions on the two-dimensional plane shown in FIG. 6.

Referring to FIG. 2, the processing device 200 is, for example, a computer including a processor such as a central processing unit (CPU). The processing device 200 may have a read only memory (ROM) in which a program is written, a random access memory (RAM) for temporarily storing data and so on. The processing device 200 includes a user registration unit 220, a divergence information management unit 222, and a user information distribution unit 224 as functional elements or functional units.

The user registration unit 220 in accordance with, for example, an instruction from an owner of the vehicle 102 generates user information 208 for each user and stores it in the storage device 202 based on information on each of the users 130, etc. who desires to use the vehicle 102. The user information 208 may include identification information (such as a user ID) on the corresponding user 130, for example, access information for accessing information on the corresponding mobile terminal 140 and key information 150 given to the mobile terminal 140, for example.

The user registration unit 220 further acquires information on a favorite tune and a frequently visited place of the corresponding user 130, for example, through the mobile terminal 140, for example, of the user 130, for example, when or after the user information 208 is generated and is stored in the storage device 202. The information can be information input by the corresponding user 130, for example, to the mobile terminal 140, for example, in response to a request from the use management server 106. If a tune playback history and a path guide history are stored in the mobile terminal 140, for example, the user registration unit 220 further acquires information on the recently listened tune and the recently visited place from the histories. Then, based on the acquired information, the user registration unit 220 generates taste information 210 on the user 130, for example, and stores it in the storage device 202.

When receiving taste information 386, which is described below, from the information processing apparatus 120 in the vehicle 102, which is described below, the user registration unit 220 further updates the taste information 210 on the corresponding user 130, for example, stored in the user DR 206 with the received taste information 386.

The divergence information management unit 222 manages taste divergence information 212 stored by the storage device 202. More specifically, the divergence information management unit 222 in accordance with, for example, an instruction from an operator who is a manager of the use management server 106 updates the taste divergence information 212 by adding a new proposal class and/or proposal category according to the instruction. The divergence information management unit 222 may include the AI (described above) for positioning a new proposal category on the two-dimensional plane shown in, for example, FIG. 4 and/or FIG. 5 included in the taste divergence information 212.

In response to reception of a transmission request from the information processing apparatus 120 in the vehicle 102, the user information distribution unit 224 transmits the taste information 210 on the user 130, for example, designated by the transmission request and the taste divergence information 212 to the information processing apparatus 120 through the communication device 204.

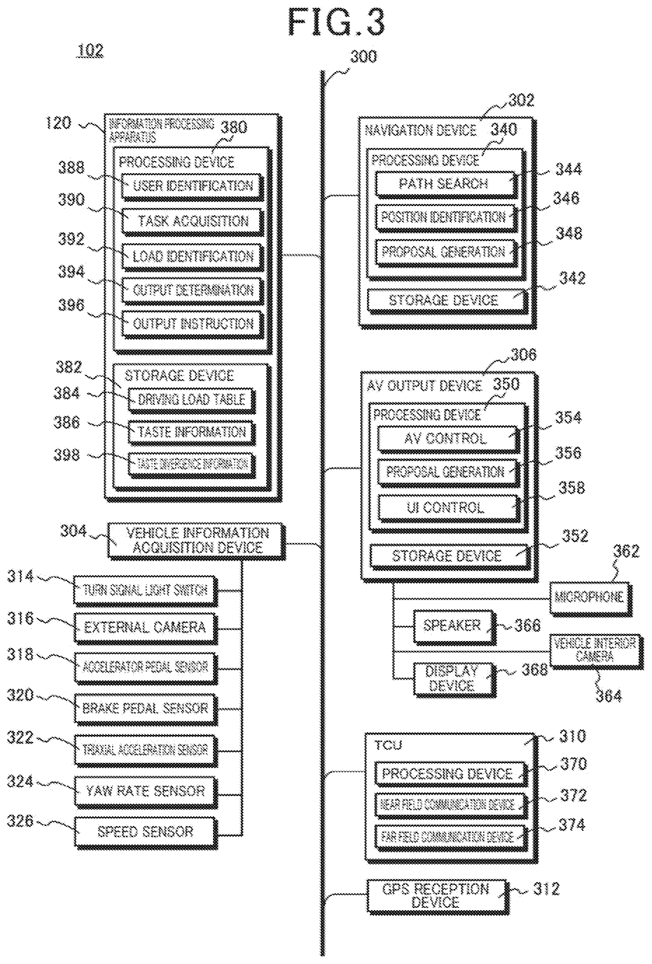

Next, a configuration of the information processing apparatus 120 included in the vehicle 102 is described. FIG. 3 is a diagram showing an example of the configuration of the information processing apparatus 120. The information processing apparatus 120 is communicably connected to other control devices included in the vehicle 102 via a vehicle-mounted network bus 300. These other control devices may include, for example, a navigation device 302, a vehicle information acquisition device 304, an audio-visual (AV) output device 306, a telematics control unit (TCU) 310, and a GPS reception device 312.

The GPS reception device 312 receives, from a GPS satellite, information for identifying a current position of the vehicle 102 (such as information regarding a longitude, a latitude and an altitude). The vehicle information acquisition device 304 acquires information regarding an ON/OFF state of a turn signal light (not shown) from a turn signal light switch 314 included in the vehicle 102. The vehicle information acquisition device 304 further acquires image information regarding external environment of the vehicle 102 from an external camera 316 that is placed on the exterior of the body of vehicle 102 and captures images of the external environment.

The vehicle information acquisition device 304 further acquires sensor information regarding the amounts of depression of an accelerator pedal and a brake pedal from an accelerator pedal sensor 318 and a brake pedal sensor 320, respectively. The vehicle information acquisition device 304 further acquires information on an acceleration of three axes of a vertical direction, a vehicle width direction and a vehicle length direction applied to the vehicle 102, information on a rotational motion about the vertical direction as the center axis and information on the speed in the vehicle length direction from a triaxial acceleration sensor 322, a yaw rate sensor 324 and a speed sensor 326.

The TCU 310 includes a near field communication device 372, a far field communication device 374, and a processing device 370 that controls operations of these communication devices. The processing device 370 is a computer including a processor such as a CPU. The near field communication device 372 is a wireless communication device that communicates with the mobile terminals 140, etc. of the users 130, etc. in accordance with, for example, Bluetooth (registered trademark) communication standard. The far field communication device 374 is a wireless communication device for communicating with, for example, the use management server 106 over the communication network 104.

The navigation device 302 includes a processing device 340 and a storage device 342. The processing device 340 is a computer including a processor such as a CPU and includes a path search unit 344, a position identification unit 346, and a proposal generation unit 348 as functional elements or functional units implemented by execution of a program.

The path search unit 344 searches a path from a current position to a destination in accordance with, for example, an instruction from the driver and, for example, displays an image showing the searched path on a display device 368 through the AV output device 306. The position identification unit 346 acquires information on a current position of the vehicle 102 based on information on GPS radio waves received by the GPS reception device 312 and outputs the information to, for example, the path search unit 344.

The proposal generation unit 348 generates a proposal regarding a stop-off point for a driver based on facial expressions of the driver acquired from a vehicle interior camera 364 through the AV output device 306, regional or local event information, for example, acquired through the TCU 310 or the like.

If the proposal generation unit 348 detects, according to a conventional technology, a physiological state of a driver from facial expressions of the driver acquired from the vehicle interior camera 364 through the AV output device 306 and detects a characteristic of fatigue in the facial expressions of the driver, the proposal generation unit 348 can make a proposal such as “Taking a break is necessary. Would you like to start the guide to a nearby park?” to the driver.

Also, for example, the proposal generation unit 348 can acquire posted text in, for example, an SNS server (not shown) connected to the communication network 104 through the TCU 310 at predetermined time intervals and, if information on a bargain sale starting time at a local supermarket is acquired, for example, the proposal generation unit 348 can make a proposal such as “A bargain sale will start from 3:00 PM at Z Supermarket. Would you like to start the guide to Z Supermarket?” to the driver.

If a proposal is generated, the proposal generation unit 348 transmits the generated proposal to the information processing apparatus 120 as a task to be presented to the driver. At that time, as information regarding the task, the proposal generation unit 348 transmits, for example, information including a voice message to be output to the driver and the proposal class and the proposal category of the proposal presented by the task to the information processing apparatus 120. In this case, the proposal class is the “STOP-OFF POINT” proposal class. The proposal category relating to the task can be determined, for example, by the proposal generation unit 348 based on the name of the stop-off point to be proposed. For the determination, a database, for example, having names of places and proposal categories in association may be stored in the storage device 342.

The AV output device 306 plays back tunes and moving pictures. The AV output device 306 also functions as a voice interaction host with another device such as the navigation device 302 as a client and outputs voice information and visual information to be presented to the driver to the speaker 366 and the display device 368 in accordance with an instruction from the other device, acquires a voice instruction from the driver through a microphone 362 and outputs a recognition result of the voice instruction to the other device. The AV output device 306 further generates a proposal to, for example, play back a tune to a driver based on facial expressions of the driver acquired from the vehicle interior camera 364.

More specifically, the AV output device 306 includes a processing device 350 and a storage device 352. The processing device 350 is a computer including a processor such as a CPU and includes an AV control unit. 354, a proposal generation unit 356, and a user interface (UI) control unit 358 as functional elements or functional units implemented by execution of a program.

According to a conventional technology, the AV control unit 354 reproduces AV content such as a tune, a moving picture and an image recorded in a removable recording medium such as a computer readable CD, DVD or USB memory and/or downloaded to and stored in the storage device 352 over, for example, the communication network 104 and outputs it to the speaker 366 and/or the display device 368. The AV control unit 354 further outputs voice of a radio program and a television program received from a receiver (not shown) for radio and television airwaves to the speaker. The AV control unit 354 further outputs a moving picture of a television program to the display device 368 in a proper case.

The UI control unit 358 in accordance with an instruction from the proposal generation unit 356 and/or the information processing apparatus 120, which is described below, displays on the display device 368 an image or a moving picture designated by the instruction and transmits an input from the driver through a touch panel (not shown) provided to the display device 368 to the proposal generation unit 356 and/or the information processing apparatus 120. The UI control unit 358 in accordance with an instruction from the proposal generation unit 356 and/or the information processing apparatus 120 outputs a voice message designated by the instruction to the speaker 366. The UI control unit 358 further acquires from the microphone 362 a speech such as a voice instruction from the driver and transmits a voice recognition result of the speech to the proposal generation unit 356 and/or the information processing apparatus 120. The UI control unit 358 further acquires an image from the vehicle interior camera 364 and outputs the acquired image itself and/or a physiological state of the driver detected from the image according to a conventional technology to other devices such as the proposal generation unit 356 and the navigation device 302.

The proposal generation unit 356 generates a proposal to play a tune to a driver based on program information acquired from radio and/or television air waves and/or facial expressions of the driver acquired from the vehicle interior camera 364. For example, if a feature program, for example, on animation songs, jazz or the like is found from the acquired program information, the proposal generation unit 348 can make a proposal such as “A feature program on “ccc” is being broadcasted. Would you like to listen?” Here, “ccc” above is a word indicating a category of the feature program, for example.

For example, if a characteristic of fatigue is recognized in facial expressions of the driver acquired from the vehicle information acquisition device 304, the proposal generation unit 348 can make a proposal such as “Would you like to play “bbb” by “aaa” ?” to the driver in order to, for example, attempt to activate the thinking activity of the driver. Here, “aaa” and “bbb” are, for example, a specific name of an artist and a specific title of a tune.

After generating a proposal, the proposal generation unit 356 transmits the generated proposal to the information processing apparatus 120 as a task to be presented to the driver. At that time, the proposal generation unit 348 transmits, to the information processing apparatus 120, information including a voice message to be output to the driver and the proposal class and the proposal category of the proposal presented by the task as, for example, information regarding the task. In this case, the proposal class is the “TUNE PLAYBACK” proposal class. The proposal category relating to the task can be, for example, determined by the proposal generation unit. 356 based on a program name of a program to be proposed as described above or an artist name and/or a composer name of a tune to be played back. For the determination, for example, a database having artist names, composer names and proposal categories in association may be stored in the storage device 352.

The information processing apparatus 120 receives the task to be presented to the driver, which is transmitted from the navigation device 302 and/or the AV output device 306. The information processing apparatus 120 then executes output of the task to the driver or stops execution of the output in accordance with the state of the driving load on the user 130, for example, being the current driver.

More specifically, the information processing apparatus 120 includes a processing device 380 and a storage device 382. The storage device 382 includes, for example, volatile and/or nonvolatile semiconductor memory and/or a hard disk drive.

The storage device 382 stores taste information 386. The taste information 386 is acquired by, when one user of the users 130, etc. starts using the vehicle 102, downloading, from the use management server 106, the taste information 210 on the corresponding user stored in the user DB 206 in the use management server 106 and storing it in the storage device 382 by a user identification unit 388, which is described below. For example, when, for example, the user 130 starts using the vehicle 102, the taste information 210 on the user 130 shown in FIG. 4 as an example of the taste information 210 is stored in the storage device 382 as the taste information 386 by the user identification unit 388.

The storage device 382 further stores taste divergence information 398. The taste divergence information 398 is acquired by, when one user of the users 130, etc. starts using the vehicle 102, downloading, from the use management server 106, the taste divergence information 212 stored in the storage device 202 in the use management server 106 and storing it in the storage device 382 by the user identification unit 388 and has the same details as those of the taste divergence information 212.

The storage device 382 further stores a driving load table 384. The driving load table 384 is a table defining the degrees of driving load of the driver of the vehicle 102 in association with various traffic scenes encountered by the vehicle 102 and is predetermined and is stored in the storage device 382.

The processing device 380 is a computer including a processor such as a CPU. The processing device 380 may have a ROM in which a program is written, a RAM for temporarily storing data and so on. The processing device 380 includes the user identification unit 388, a task acquisition unit 390, a load identification unit 392, an output determination unit 394, and an output instruction unit 396 as functional elements or functional units.

These functional elements included in the processing device 380 are implemented by, for example, execution of a program by the processing device 380 being a computer. The computer program can be stored in an arbitrary computer readable storage medium. Instead of that, each of all or a part of the functional elements included in the processing device 380 can be configured by hardware including one or more electronic circuit parts.

When one user of the users 130, etc. starts using the vehicle 102 by using an electronic key in the corresponding one of the mobile terminals 140, etc., the user identification unit 388 identifies the user as the current driver from the key information 150, etc. on the used electronic key. According to a conventional technology, the key information 150, etc. can be received and acquired by, for example, the TCU 310 through the near field communication device 372, be transmitted to a control device (not shown) that performs key authentication and be transmitted to the information processing apparatus 120.

The user identification unit 388 further communicates with the use management server 106 and downloads the taste information 210 on the identified user from the user DB 206 in the use management server 106. Then, the user identification unit 388, as described above, stores the downloaded taste information 210 on the user being the current driver in the storage device 382 as the taste information 386. The user identification unit 388 further downloads the taste divergence information 212 from the use management server 106 and stores it in the storage device 382 as the taste divergence information 398.

The task acquisition unit 390 receives and acquires a task to be presented to the driver, which is transmitted from the navigation device 302 and/or the AV output device 306.

The load identification unit 392 identifies the current driving load on the current driver. More specifically, the load identification unit 392 acquires information on traffic environment (such as distinction of an area near an intersection, before a railroad crossing or at an entrance of a highway) with respect to the current position of the vehicle 102 from the navigation device 302. The load identification unit 392 further acquires, from the vehicle information acquisition device 304, information regarding the current operating state (such as constant-speed driving or accelerating/decelerating driving) of the vehicle 102 and information on an operating state of a traffic infrastructure (such as a lighting state of a traffic signal) in a traffic environment.

Then, the load identification unit 392 identifies a traffic scene in which the vehicle 102 is currently placed (such as constant-speed straight driving, lane changing, starting after a signal stop) based on the acquired information and identifies the degree of the driving load corresponding to the identified traffic scene. More specifically, the load identification unit 392 refers to the driving load table 384 stored in the storage device 382 and thus identifies the magnitude of the driving load corresponding to the identified traffic scene.

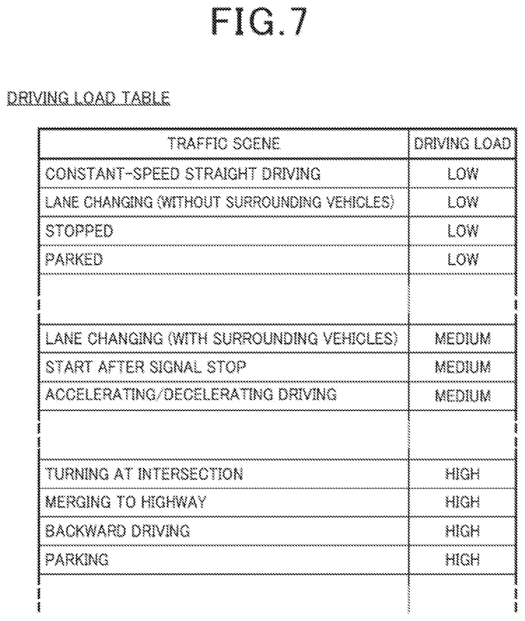

FIG. 7 is a diagram showing an example of the driving load table 384. In the shown example, various traffic scenes are shown in the left columns of the table, and three levels of “HIGH”, “MEDIUM”, and “LOW” are given in the corresponding right columns as the degrees of driving loads in the traffic scenes. For example, in a case where the current traffic scene determined from the information acquired from the navigation device 302 and/or the vehicle information acquisition device 304 is “LANE CHANGING (WITH SURROUNDING VEHICLES)”, the load identification unit 392 determines “MEDIUM” as the current driving load of the driver of the vehicle 102 based on the driving load table 384 shown in FIG. 7.

The output determination unit 394 determines whether the task acquired by the task acquisition unit 390 is to be output to the current driver or not in accordance with the current driving load identified by the load identification unit 392. Particularly, the output determination unit 394 calculates the degree of divergence between a proposal included in the acquired task and the taste of the user 130, for example, being the current driver based on the taste information 386 on the current driver stored in the storage device 332. In other words, the degree of divergence between the proposal included in the task and the taste of the user 130, for example, is calculated for each user who is using the vehicle 102 as the driver at that time.

For example, the output determination unit 394 identifies the position of the proposal category of the task on the two-dimensional plane of the taste divergence information shown in FIG. 5 and FIG. 6 from the proposal class and the proposal category of the proposal included in the task. The output determination unit 394 further identifies the taste class and the taste category of the user 130, for example, being the current driver with reference to the taste information 386 and identifies the position of the taste category of the identified user 130, for example, on the two-dimensional plane being the taste divergence information corresponding to the proposal class of the task. In this case, the correspondence relationship between the taste class and the proposal class can be predetermined and be stored in the storage device 382. In this embodiment, the taste classes “FAVORITE TUNE” and “RECENTLY LISTENED TUNE” correspond to the proposal class “TUNE PLAYBACK”, and taste classes “FREQUENTLY VISITED PLACE” and “RECENTLY VISITED PLACE” correspond to the proposal class “STOP-OFF POINT”.

The output determination unit 394 then calculates, as the degree of divergence, the distance between the proposal category of the acquired task and the taste category of the driver on the two-dimensional plane being the taste divergence information corresponding to the proposal class of the task. When a plurality of taste categories exist in one taste class in the taste information 386 on the user 130, for example, the output determination unit 394 can calculate, as the degree of divergence, a minimum value, for example, of distances between the proposal category of the acquired task and the taste categories.

In addition to the operations above, the output determination unit 394 can calculate the degree of divergence also based on the learning level of response to a task (learning level of task response) of the user 130, for example, being the driver. The learning level of task response can be expressed by a ratio of the average time of the last predetermined number of task responses by the user 130, for example, to the average time of task responses of a standard driver (the average time from the outputs of task proposals to the responses) predetermined and stored in the storage device 382.

For example, the output determination unit 394 can store response times of task responses by the user 130, for example, being the current driver in advance and multiply the degree of divergence acquired from the taste divergence information 398 by the ratio to calculate the degree of divergence to be used for subsequent processing.

If the calculated degree of divergence is smaller than a threshold value calculated based on the driving load identified in the load identification unit. 392, the output determination unit 394 determines to output the request of the task to the driver. Here, the threshold value is calculated for each proposal class. The threshold value is set to be smaller as the driving load is larger. Thus, with a higher driving load, only tasks including proposals with lower degrees of divergence are output to the driver.

If the output determination unit 394 determines to output the acquired task, the output determination unit 394 instructs, for example, the AV output device 306 to voice-output the task and transmits a response reception instruction that instructs to receive a response from the driver with respect to the task to the navigation device 302 or the AV output device 306 from which the task is acquired. On the other hand, if the output determination unit 394 determines not to output the acquired task, the output determination unit 394 transmits an output disability notification on the task to the navigation device 302 or the AV output device 306 from which the task is acquired.

When the navigation device 302 or the AV output device 306 receives the response reception instruction regarding the generated task from the output determination unit 394, the navigation device 302 or the AV output device 306 acquires a voice recognition result relating to a voice response of the driver to the task through the UI control unit 358 in the AV output device 306 according to a conventional technology. The navigation device 302 or the AV output device 306 then starts or stops execution of the operation proposed in the task in accordance with the acquired response.

On the other hand, when receiving the output disability notification regarding the generated task, the navigation device 302 or the AV output device 306 abandons the task or proposal without performing the operation proposed in the task.

In the information processing system 100 having the above-described configuration, a task to be responded by a driver is acquired from the navigation device 302, for example, and whether the task is to be output to the driver or not is determined based on the current driving load. More specifically, in the information processing system 100, the degree of divergence of a proposal included in a task to be presented from a taste of the user 130, for example, being the current driver is calculated, and, if the degree of divergence is smaller than a threshold value according to the current driving load on the vehicle 102, the task is output to the driver.

Thus, in the information processing system 100, with a higher driving load, only tasks including proposals having small degrees of divergence from tastes of the driver are output. In other words, with a higher driving load, because the output of tasks including proposals having large degrees of divergence from tastes of the driver is limited, distraction of attention to driving operations by being confused about the determination of a response to the task, resulting in dispersion of thinking and concentration of the driver, can be prevented. Therefore, in the information processing system 100, various tasks including proposals to the driver can be safely presented without excessively dissipating the attention to driving operations by the driver.

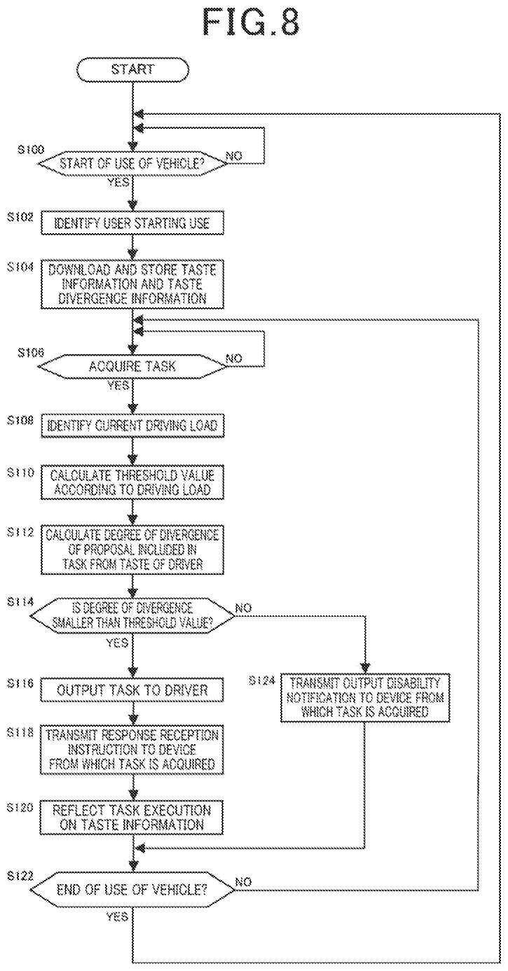

Next, an operating procedure of the information processing system 100 is described. FIG. 8 is a flowchart showing a procedure of operations in the information processing system 100. This processing starts when the information processing apparatus 120 is powered on at a state that a power supply to the use management server 106 included in the information processing system 100 has an ON state and ends when the information processing apparatus 120 is powered off.

When the processing starts, the user identification unit 388 in the information processing apparatus 120 first determines whether use of the vehicle 102 is started or not (S100). For example, when the user identification unit 388 receives information on the key information 150, for example, transmitted from the mobile terminal 140, for example, of the user 130, for example, starting the use of the vehicle 102 from the TCU 310, the user identification unit 388 determines that the use of the vehicle 102 is started.

Then, if the use of the vehicle 102 is not started (NO in S100), the user identification unit 388 returns to step S100 and repeats the processing. On the other hand, if the use of the vehicle 102 is started (YES in S100), the user identification unit 388 identifies the user 130, for example, starting the use of the vehicle 102 from the key information 150, for example, received from the TCU 310 according to a conventional technology (S102). In this embodiment, the user is one of the users 130, 132 and 134.

Subsequently, the user identification unit 388 downloads, from the use management server 106, the taste information 210 regarding the identified user 130, for example, and the taste divergence information 212 and stores them in the storage device 382 as the taste information 386 and the taste divergence information 398 (S104).

Next, the task acquisition unit 390 determines whether a task transmitted from the navigation device 302 and/or the AV output device 306 is received and is acquired or not (S106). If no task is acquired (NO in S106), the task acquisition unit 390 returns to step S106 and repeats the processing. If a task is acquired (YES in S106), the load identification unit 392 identifies the current driving load (S108). The load identification unit. 392 outputs information on the identified driving load to the output determination unit 394.

Next, the output determination unit 394 calculates a threshold value according to the current driving load that is identified above (S110). The output determination unit 394 further calculates the degree of divergence of a proposal included in the acquired task from a taste of the user 130, for example, being the current driver (S112). Subsequently, the output determination unit 394 determines whether the calculated degree of divergence is smaller than the calculated threshold value or not (S114).

If the degree of divergence is smaller than the threshold value (YES in S114), the output determination unit 394 determines to output the acquired task to the driver and outputs the task (S116). As described above, the output of the task can be performed by instructing the AV output device 306 to voice-output the task. Subsequently, the output instruction unit 396 transmits a response reception instruction that instructs reception of a response from the driver with respect to the task to the navigation device 302 or the AV output device 306 from which the task is acquired (S118).

The output instruction unit 396 further reflects details of the proposal to be executed by the output task on the taste information 386 (S120). More specifically, the output instruction unit 396 inquires the AV output device 306 about whether a tune proposed by the task has been played or not, and, if the tune has been played, adds the information on the tune to the taste class “RECENTLY LISTENED TUNE”. The output instruction unit 396 further inquires the navigation device 302 about whether, for example, the stop-off point proposed by the task has been set as a destination or not, and, if the stop-off point has been set, adds the information on the stop-off point to the taste class “RECENTLY VISITED PLACE”. When proposal details of the task are reflected on the taste information 386, the output instruction unit 396 transmits the taste information 386 after the reflection to the use management server.

Next, the user identification unit 388 determines whether the use of the vehicle 102 by the current user ends or not (S122). This determination can be performed by detecting that, for example, the user 130, for example, being the current driver has turned off the driving device for the vehicle 102 and has locked vehicle doors according to a conventional technology. Then, if the use of the vehicle 102 ends (YES in S122), the user identification unit 388 returns to step S100 and repeats the processing. On the other hand, if the use of the vehicle 102 does not end (NO in S122), the user identification unit 388 returns to step S106 and repeats the processing.

On the other hand, if the degree of divergence is equal to or larger than the threshold value in step S114 (NO in S114), the output determination unit 394 transmits an output disability notification to the device from which the task is acquired, that is, the navigation device 302 or the AV output device 306 in this embodiment (S124). After that, the output determination unit 394 moves the processing to step S122.

### Variation Examples

Next, variation examples of the information processing system 100 are described. Although, in the description above, the output determination unit 394 calculates the threshold value to be compared with the degree of divergence for determining whether the task is to be output or not only based on the driving load, how the threshold value is determined is not limited thereto.

As a variation example, instead of the operation above, the output determination unit 394 may determine whether the task output to the driver is to be performed or not by using two kinds of threshold values including a default threshold value not dependent on an individual user (that is, the driver) and an inherent threshold value dependent on each user. Here, the default threshold value can be a standard threshold value predetermined in accordance with the magnitude of the driving load and stored in the storage device 382. The output determination unit 394 can use the default threshold value for a user not satisfying a predetermined condition regarding the task learning level, for example, and use the inherent threshold value for a user satisfying a predetermined condition.

The predetermined condition can be arbitrarily determined, and one or a plurality of conditions may be determined. When a plurality of predetermined conditions are provided and every time one of the predetermined conditions is satisfied by one task, an inherent threshold value corresponding to the satisfied predetermined condition can be determined.

The predetermined conditions can include, for example, conditions “a response to a task has been made even once by the user” and/or “a response to a task has been made a predetermined number of times or higher (such as three or more times) by the user within a predetermined period (such as three months)”.

The method for calculating the inherent threshold value can be arbitrarily determined. For example, the inherent threshold value can be calculated by multiplying the default threshold value by a reciprocal of a ratio of the average time of the last predetermined number of task responses by the user 130, for example, to the average time of task responses by a standard driver predetermined and stored in the storage device 382. For the calculation of the ratio, the output determination unit 394 can store an actual value of a response time of a response to a task every time the user 130, for example, who is currently using the vehicle 102 responds to the task.

The present invention is not limited to the configuration of the above-described embodiment but is implemented in various embodiments without departing from the spirit and scope.

For example, having described that, according to the above-described embodiment, the vehicle 102 is a shared car as an example, the vehicle 102 is not limited thereto. The vehicle 102 can be an arbitrary kind of mobile unit that is used for an arbitrary purpose. For example, the vehicle 102 may be a private vehicle or a bus, a two-wheel vehicle or other arbitrary mobile units. When the vehicle 102 is a two-wheel vehicle, the user interface of the speaker 366 and the microphone 362 can be a head set communicably connected to the AV output device 306 via, for example, Bluetooth, and a task can be output through the head set.

Although, in the above-described embodiment, the vehicle 102 is used by one of the three users 130, 132 and 134, the number of users who use the vehicle 102 as a driver is not limited to three. The number of users who can use the vehicle 102 can be any arbitrary number equal to or higher than one.

Although, in the above-described embodiment, the information processing system 100 includes one information processing apparatus 120 mounted on one vehicle 102 and the use management server 106 as an example, the number of the information processing apparatus 120 included in the information processing system 100 is not limited to one. The number of the information processing apparatus 120 to be included in the information processing system 100 can be an arbitrary number of information processing apparatuses mounted on an arbitrary number of vehicles equal to or higher than one such as the vehicle 102.

In this case, also when the user 130, for example, uses the plurality of vehicles 102, a task according to the driving load can be presented to the user in each of the vehicles by the information processing apparatus 120 in the vehicle 102 currently being driven by the user based on the taste information 210 on the user himself or herself stored in the storage device 202 in the use management server 106. For example, the use management server 106 may give a unique identifier (ID) to each of the users 130, etc. and store the user information 208 and the taste information 210 in association with the ID, and the key information 150 on the mobile terminal 140, for example, held by the user 130, for example, includes the ID of the user.

Thus, when the use management server 106 receives a transmission request from the information processing apparatus 120 in an arbitrary vehicle 102, the use management server 106 can transmit the taste information 210 on the corresponding user to the information processing apparatus 120 in the vehicle 102 being currently used by the user based on, for example, the ID of the user and an identification code of the vehicle 102 included in the transmission request.

Alternatively, the information processing system 100 may not include the use management server 106 provided externally to the vehicle 102, but the information processing system 100 may include a use management device having the same functions as the processing device 200 and the storage device 202 of the use management server 106 in the vehicle 102 having the information processing apparatus 120. In this case, the use management device and the information processing apparatus 120 are communicably connected via the vehicle-mounted network bus 300, and an information processing system similar to the information processing system 100 is implemented within the vehicle 102.

Although, according to the above-described embodiment, a proposal of a stop-off point from the navigation device 302 and a proposal of tune playback from the AV output device 306 as shown in FIG. 4 are described as examples of a task to be handled by the information processing system 100, the proposal to be presented to a driver by a task is not limited thereto. The proposal to be handled by the information processing system 100 can be an arbitrary proposal if the degree of divergence from a taste of the driver can be defined. Such a proposal may be a proposal to record voice and/or video of a specific program if, for example, the AV output device 306 can record voice or video of a broadcast program on, for example, a radio or a television.

Although, according to the above-described embodiment, the information processing apparatus 120 acquires a proposal from the navigation device 302 and the AV output device 306, the device from which a proposal is acquired by the information processing apparatus 120 is not limited thereto. The information processing apparatus 120 can acquire a proposal to a driver from an arbitrary device.

Although, according to the above-described embodiment, the information processing apparatus 120 acquires a proposal that can be responded with “YES” or “NO” by a driver of the vehicle 102 through the navigation device 302 and the AV output device 306, the form of the proposal to be presented to the driver is not limited thereto. The proposal to be acquired by the information processing apparatus 120 can be a proposal that, for example, prompts the driver to select one or more choices from a plurality of choices.

In this case, the output determination unit 394 can calculate the degree of divergence of the task from a taste of a driver based on the degrees of divergence from a taste of the driver of the plurality of choices presented by the task. For example, the output determination unit 394 can calculate an average value or a minimum value of the degrees of divergence calculated for the plurality of choices as the degree of divergence of the task. The output determination unit 394 can determine whether the task is to be output to the driver or not based on the calculated degree of divergence of the task.

In this case, the difficulty of the response to a task varies in accordance with the number of choices included in the task, and the relationship between the number of choices and the difficulty differs among individual users. Therefore, the above-described learning level of task response that can be considered for calculation of the degree of divergence of the task can include the learning level of response to the task from a viewpoint of the number of choices included in the task. The learning level of task response from a viewpoint of the number of choices can be expressed by, for example, a ratio of an average time of task responses to tasks having various numbers of choices in the last predetermined number of task responses by the user 130, for example, to a standard average time of task responses to the corresponding number of choices by a standard driver, which is predetermined and is stored in the storage device 382.

The output determination unit 394 can store in advance, for example, response times of task responses by the user 130, for example, being the current driver for each number of choices included in the corresponding tasks and, when an individual and specific task is acquired from the AV output device 306, for example, the ratio described above can be calculated in accordance with the number of choices included in the acquired task. The output determination unit 394 can then calculate the degree of divergence to be used for subsequent processing by multiplying the calculated ratio by the degree of divergence of the task acquired from the taste divergence information 398.

Although, in the information processing system 100 of the above-described embodiment, the degree of driving load to be identified by the load identification unit 392 in the information processing apparatus 120 has three levels of “HIGH”, “MEDIUM” and “LOW” as shown in FIG. 6, for example, the representation of the driving load is not limited thereto. The magnitude of the driving load can be represented by three or more levels or can be represented as serial values.

Although, in the information processing system 100 of the above-described embodiment, the threshold value regarding the degree of divergence to be used for determining whether a task is to be output or not by the output determination unit 394 in the information processing apparatus 120 is provided for each of proposal classes such as “TUNE PLAYBACK” and “STOP-OFF POINT”, the configuration of the information processing system 100 is not limited thereto. The threshold value may be one threshold value for a plurality of proposal classes, depending on the scale applied on the two-dimensional coordinate system for each proposal class the examples of which are shown in FIG. 5 and FIG. 6, to determine whether the task is to be output or not.

Although, in the information processing system 100 of the above-described embodiment, the threshold value regarding the degree of divergence to be used for determining whether a task is to be output or not by the output determination unit 394 in the information processing apparatus 120 is determined only in accordance with the driving load, the configuration of the information processing system 100 is not limited thereto. The threshold value can be determined in consideration of a parameter other than those described above.

For example, a threshold value can be calculated also in consideration of the learning level of driving operations of the corresponding user 130, for example. Such a learning level of driving operations can be given based on a difference value acquired by subtracting an operating time required for each of a lane changing operation, a turning operation, a decelerating operation and so on by the user 130, for example, when the user 130, for example, can concentrate on the driving operations (such as a state that no task presentation is performed) from a standard time (such as an average value among an indefinite number of drivers) for the corresponding driving operation. The difference value can be a positive value having an absolute value that is increased as the learning level for the corresponding operation increases.

Based on the driving load identified by the load identification unit 392, the output determination unit 394 can calculate a threshold value to be actually used by, for example, performing weighting addition of an average value of the difference values for all operations (that is, by adding a value acquired by multiplying the average value by a predetermined value) to a threshold value predetermined in accordance with the driving load. Thus, a larger threshold value is applied to a user having a higher learning level for the driving operations, and more tasks including a proposal having a larger degree of divergence can be presented compared to other users having an equal driving load.

As described above, the above-described information processing system 100 includes the task acquisition unit 390 configured to acquire a task to be presented to a driver of the vehicle 102 being a mobile unit, the load identification unit 392 configured to identify a current driving load on the driver, the output determination unit 394 configured to determine whether the acquired task is to be output to the driver or not in accordance with the driving load, and the storage device 202, 382 being a storage unit. The storage device 202, 382 stores the taste information 210, 386 regarding a taste of the driver. The output determination unit 394 calculates a degree of divergence of the acquired task from the taste of the driver based on the taste information 210, 386 on the driver. The output determination unit 394 determines to output a request of the acquired task to the driver if the calculated degree of divergence is smaller than a threshold value calculated based on the identified driving load.

According to this configuration, because only tasks having smaller degrees of divergence from tastes of the driver are proposed as the driving load increases, the degrees of thinking ability required for determination on responses to the tasks are small in the driver. As a result, in the information processing system 100, various tasks can be safely presented in accordance with the driving loads without excessively dissipating the attention to driving operations of the driver.

In the information processing system 100, the task includes a proposal to the driver, and the output determination unit 394 calculates the degree of divergence of the proposal included in the acquired task from the taste of the driver based on the taste information on the driver. According to this configuration, various tasks can be safely presented in accordance with the driving loads without excessively dissipating the attention to driving operations of the driver.

In the information processing system 100, the storage device 202, 382 being a storage unit stores the taste divergence information 212, 398 on a mutual degree of divergence between a plurality of predetermined taste categories. The output determination unit 394 calculates a degree of divergence of the proposal included in the acquired task from the taste of the driver based on the taste divergence information 212, 398.

According to this configuration, a degree of divergence between a proposal included in the acquired task and a taste of the driver can be easily calculated.

In the information processing system 100, the threshold value is set to be smaller as the driving load is larger. According to this configuration, because, as the driving load increases, only proposals having smaller degrees of divergence from tastes of the driver are output, various tasks can be safely presented in accordance with the driving loads in a more effective manner without excessively dissipating the attention to driving operations of the driver.

In the information processing system 100, the threshold value can include a default threshold value not dependent on an individual driver and an inherent threshold value determined for each driver. The output determination unit 394 can determine whether the acquired task is to be output to the driver or not by using the inherent threshold value if a predetermined condition about the learning level of response of the driver with respect to the task is satisfied. According to this configuration, because, for example, more tasks can be output to a user having a higher learning level of task response, a highly convenient system suitable for an individual user can be configured.

The taste information 386 is determined for the driver, that is, for each of the users 130, etc. who can be the driver of the vehicle 102. According to this configuration, based on a taste of the driver, the degree of divergence between a proposal included in a task and the taste of the driver can be calculated as a value peculiar to the current driver. For that, in the information processing system 100, various tasks can be safely presented in accordance with the tastes of each of the users 130, etc.

In the information processing system 100, an information processing method including the steps of acquiring a task to be presented to a driver of the vehicle 102 being a mobile unit by the task acquisition unit 390 (S106), identifying a current driving load on the driver by the load identification unit 392 (S108), and determining whether a request of the acquired task is to be output to the driver or not by the output determination unit 394 (S112, S114) is executed. The determining calculates a degree of divergence of the acquired task from the taste of the driver based on the taste information regarding a taste of the driver stored in a storage unit (S112) and determines to output a request of the acquired task to the driver if the calculated degree of divergence is smaller than a threshold value calculated based on the identified driving load (S114).

According to this configuration, because only tasks having smaller degrees of divergence from tastes of the driver are proposed as the driving load increases, the degrees of thinking ability required for determination on responses to the tasks are small in the driver. As a result, in the information processing system 100, various tasks can be safely presented in accordance with the driving loads without excessively dissipating the attention to driving operations of the driver.

### REFERENCE SIGNS LIST

100: information processing system, 102: vehicle, 104: communication network, 106: use management server, 120: information processing apparatus, 130, 132, 134: user, 140, 142, 144: mobile terminal, 150, 152, 154: key information, 200, 340, 350, 370, 380: processing device, 202, 342, 352, 382: storage device, 204: communication device, 206: user DB, 208: user information, 210, 386: taste information, 212, 398: taste divergence information, 220: user registration unit, 222: divergence information management unit, 224: user information distribution unit, 300: vehicle-mounted network bus, 302: navigation device, 304: vehicle information acquisition device, 306: AV output device, 310: TCU, 312: GPS reception device, 314: turn signal light switch, 316: external camera, 318: accelerator pedal sensor, 320: brake pedal sensor, 322: triaxial acceleration sensor, 324: yaw rate sensor, 326: speed sensor, 348, 356: proposal generation unit, 344: path search unit, 346: position identification unit, 354: AV control unit, 358: UI control unit, 362: microphone, 364: vehicle interior camera, 366: speaker, 368: display device, 372: near field communication device, 374: far field communication device, 384: driving load table, 388: user identification unit, 390: task acquisition unit, 392: load identification unit, 394: output determination unit, 396: output instruction unit

What is claimed is:

1. An information processing system comprising:
a task acquisition unit configured to acquire a task to be presented to a driver of a mobile unit;
a load identification unit configured to identify a current driving load on the driver;
an output determination unit configured to determine whether the acquired task is to be output to the driver or not in accordance with the driving load; and
a storage unit,
wherein the storage unit stores taste information regarding a taste of the driver, and
the output determination unit
calculates a degree of divergence of the acquired task from the taste of the driver based on the taste information on the driver, and
determines to output a request of the acquired task to the driver if the calculated degree of divergence is smaller than a threshold value calculated based on the identified driving load.

2. The information processing system according to claim 1, wherein
the task includes a proposal to the driver, and
the output determination unit calculates the degree of divergence of the proposal included in the acquired task from the taste of the driver based on the taste information on the driver.

3. The information processing system according to claim 2, wherein
the storage unit stores taste divergence information on a mutual degree of divergence between a plurality of predetermined taste categories, and
the output determination unit calculates a degree of divergence of the proposal included in the acquired task from the taste of the driver based on the taste divergence information.

4. The information processing system according to claim 1, wherein the threshold value is set to be smaller as the driving load is larger.

5. The information processing system according to claim 1, wherein the taste information is determined for the driver.

6. The information processing system according to claim 1, wherein
the threshold value includes a default threshold value not dependent on an individual driver and an inherent threshold value determined for each driver, and
the output determination unit determines whether the acquired task is to be output to the driver or not by using the inherent threshold value if the driver satisfies a predetermined condition relating to a learning level of response with respect to the task.

7. An information processing method comprising the steps of:
acquiring a task to be presented to a driver of a mobile unit by a task acquisition unit;
identifying a current driving load on the driver by a load identification unit; and
determining whether a request of the acquired task is to be output to the driver or not by an output determination unit,
wherein in the determining,
a degree of divergence of the acquired task from the taste of the driver is calculated based on taste information regarding a taste of the driver stored in a storage unit, and
a request of the acquired task is determined to be output to the driver if the calculated degree of divergence is smaller than a threshold value calculated based on the identified driving load.
